(19) United States
(12) Patent Application Publication
(10) Pub. No.: US 2006/0041705 A1
(43) Pub. Date: Feb. 23, 2006

(54) SYSTEM AND METHOD FOR ARBITRATION BETWEEN SHARED PERIPHERAL CORE DEVICES IN SYSTEM ON CHIP ARCHITECTURES

(75) Inventors: Serafino Bueti, Waterbury, VT (US); Kenneth J. Goodnow, Essex, VT (US); Gregory J. Mann, Winfield, IL (US); Jason M. Norman, South Burlington, VT (US); Scott T. Vento, Essex Junction, VT (US)

Correspondence Address: CANTOR COLBURN LLP, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 10/711,084

(22) Filed: Aug. 20, 2004

(51) Int. Cl. G06F 13/36

(52) U.S. Cl. 710/309

(57) ABSTRACT

A system for implementing arbitration between one or more shared peripheral core devices in system on chip (SOC) integrated circuit architecture includes a first microprocessor in communication with a first system bus, and a second microprocessor in communication with a second system bus. At least one peripheral core device is accessible by both the first microprocessor and said second microprocessor, and an arbitration unit is in communication with the first system bus and the second system bus. The arbitration unit is configured to control communication between the at least one peripheral core device and the first and second microprocessors.

### BACKGROUND OF INVENTION

The present invention relates generally to computer system on chip architectures, and, more particularly, to a system and method for implementing arbitration between shared peripheral core devices in system on chip (SOC) architectures.

Recent advances in silicon densities now allow for the integration of numerous functions onto a single silicon chip. With this increased density, peripherals formerly attached to the processor at the card level are now integrated onto the same die as the processor. As a result, chip designers must now address issues traditionally handled by the system designer. For example, the on-chip buses used in such system on chip (SOC) designs must be sufficiently flexible and robust in order to support a wide variety of embedded system needs. Typically, an SOC contains numerous functional blocks representing a very large number of logic gates, the designs of which may be realized through a macro-based approach. Macro-based designs provide numerous benefits during logic entry and verification. From generic serial ports to complex memory controllers and processor cores, each SOC generally requires the use of common macros.

In modern SOC design architectures, there may be many processors each needing to share the same peripheral cores. Although still necessary, many of these peripheral cores are actually used on an infrequent basis. In the case where a separate set of peripheral cores is placed on the SOC for each individual processor in the system, the result is a great deal of device redundancy and wasted silicon. On the other hand, if the system were to provide a method of sharing each peripheral among several processors, this redundancy would be eliminated. One possible solution in this regard could be to connect each processor to the same system bus and to share a small number of peripherals over the same bus. However, this approach is often impractical, since the bandwidth of the system bus may not support several processors.

Accordingly, it would be desirable to be able to implement an SOC architecture that would remove much of the previous redundancy by sharing lesser used peripherals, but that would also maintain separate system busses to support several processors.

### SUMMARY OF INVENTION

The foregoing discussed drawbacks and deficiencies of the prior art are overcome or alleviated by a system for implementing arbitration between one or more shared peripheral core devices in system on chip (SOC) integrated circuit architecture. In an exemplary embodiment, the system includes a first microprocessor in communication with a first system bus, and a second microprocessor in communication with a second system bus. At least one peripheral core device is accessible by both the first microprocessor and said second microprocessor, and an arbitration unit is in communication with the first system bus and the second system bus. The arbitration unit is configured to control communication between the at least one peripheral core device and the first and second microprocessors.

In another embodiment, a method for implementing arbitration between one or more shared peripheral core devices in a system on chip (SOC) integrated circuit architecture includes configuring a first microprocessor in communication with a first system bus, configuring a second microprocessor in communication with a second system bus, and configuring at least one peripheral core device to be accessible by both the first microprocessor and the second microprocessor. An arbitration unit is configured in communication with the first system bus and the second system bus, wherein the arbitration unit controls communication between the at least one peripheral core device and the first and second microprocessors.

### BRIEF DESCRIPTION OF DRAWINGS

Referring to the exemplary drawings wherein like elements are numbered alike in the several Figures:

FIG. 1 is a block diagram of an existing system on a chip (SOC) architecture;

FIG. 2 is a block diagram of a SOC architecture, configured for implementing arbitration between shared peripheral core devices, in accordance with an embodiment of the invention;

FIG. 3 is a schematic diagram of a first embodiment of an individual arbitration unit of FIG. 2;

FIG. 4 is a schematic diagram of a second embodiment of an individual arbitration unit of FIG. 2;

FIG. 5 is a schematic diagram of a third embodiment of an individual arbitration unit of FIG. 2; and

FIG. 6 is a schematic diagram of a fourth embodiment of an individual arbitration unit of FIG. 2.

### DETAILED DESCRIPTION

Disclosed herein is a system and method for implementing arbitration between shared peripheral core devices in system on chip (SOC) architectures. For architectures in which an SOC includes several processors that all need access to a given set of cores, a single set of cores is provided on the chip (rather than providing a separate set of cores for each processor), wherein the processors share use of the cores as needed. Briefly stated, the present disclosure introduces an arbitration unit that manages the complex function of multiplexing a small number of identical peripheral cores among several processors. The arbitration unit is configured to independently connect to each separate processor bus. Where several types of peripheral cores are to be shared in this manner, an arbitration unit is used for each type of peripheral.

Referring initially to FIG. 1, there is shown a block diagram of an existing system on a chip (SOC) architecture 100, including a first microprocessor 102a and a second microprocessor 102b, each in communication with a separate processor bus 104a, 104b, respectively. As indicated above, a present approach for attaching peripherals to multiple processor busses is to implement two fully separate systems, each containing its own system bus and peripheral sets. Thus, for example, first processor 102a has access, through bus 104a, to three peripheral sets: (a_{—}1, a_{—}2), (b_{—}1, b_{—}2), and (c_{—}1, c_{—}2). Similarly, second processor 102b has access, through bus 104b, to three separate peripheral sets: (a_{—}3, a_{—}4), (b_{—}3, b_{—}4), and (c_{—}3, c_{—}4). Although such an arrangement may be fully functional for the desired capabilities of the SOC architecture 100, the redundant set of peripheral cores unnecessarily consumes device real estate.

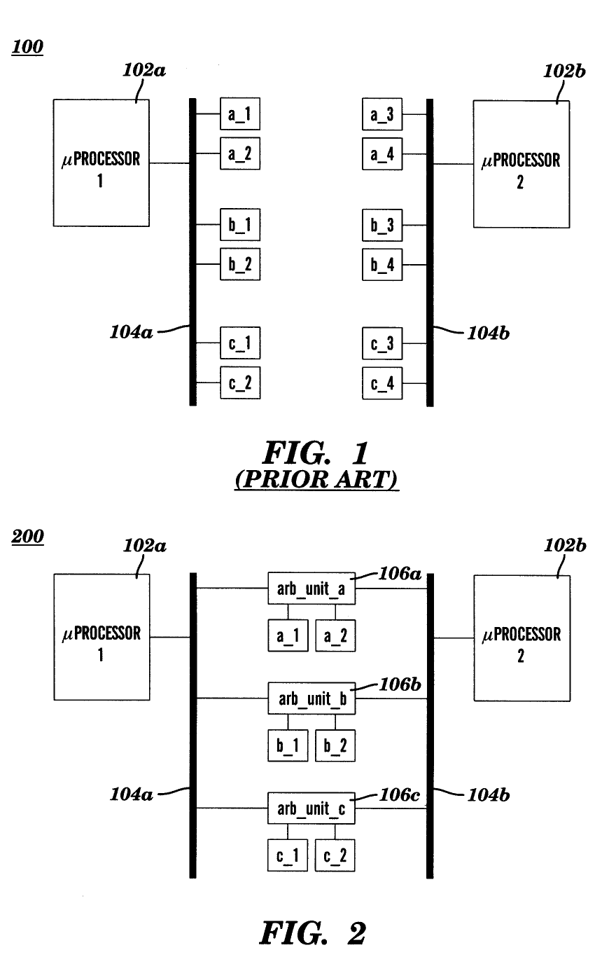

Therefore, in accordance with an embodiment of the invention, FIG. 2 is a block diagram of a novel system on a chip (SOC) architecture 200, configured for implementing arbitration between shared peripheral core devices. Although each processor 102a, 102b is still provided with its own processor bus 104a, 104b, each set of peripheral devices (a_{—}1, a_{—}2), (b_{—}1, b_{—}2), and (c_{—}1, c_{—}2) is accessible by both processors and busses. In order to manage access by the processors and processor busses to the peripheral devices, a set of arbitration units 106a, 106b, 106c is provided for each set of peripherals. It should be noted that although the examples depicted herein illustrate two processors, the principles of the present invention embodiments are equally applicable to architecture having several processors and associated busses.

Though the arbitration functions for external I/O's may differ depending on the embodiment, the arbitration protocol between a processor and a given peripheral core is consistent. More specifically, an arbitration unit associated with a particular peripheral is able to detect an appropriate request for that peripheral by either processor 102a or processor 102b. This may be implemented through simple addressing methods. Once a request is detected, the arbitration unit will inspect its internal registers to determine which peripheral, if any, is presently free to handle the request. If a free peripheral is detected, the arbitration unit notes the assignment internally, and data passes between the free peripheral as needed. On the other hand, if a free peripheral is not found, the arbitration utilizes the corresponding system bus to inform the requesting processor that the requested peripheral is busy. This status will be continuously updated until such time as a peripheral becomes available.

In addition, each arbitration unit may also implement data buffering on the processor bus interface and the external I/O to allow itself to store certain data transfers in the event that all peripherals are busy at a given time. This type of buffering would preferably be implemented in a manner such that data could be multiplexed (muxed) in and out so that it is not used when the peripheral devices are not busy. As described in further detail hereinafter, there are least four ways that an arbitration unit could be internally configured, based on the type of peripheral core connected thereto:
1. No external I/O;
2. External output only;
3. External input and output, response based; and
4. External input and output, arbitrary.

### Embodiment 1

### No External I/O

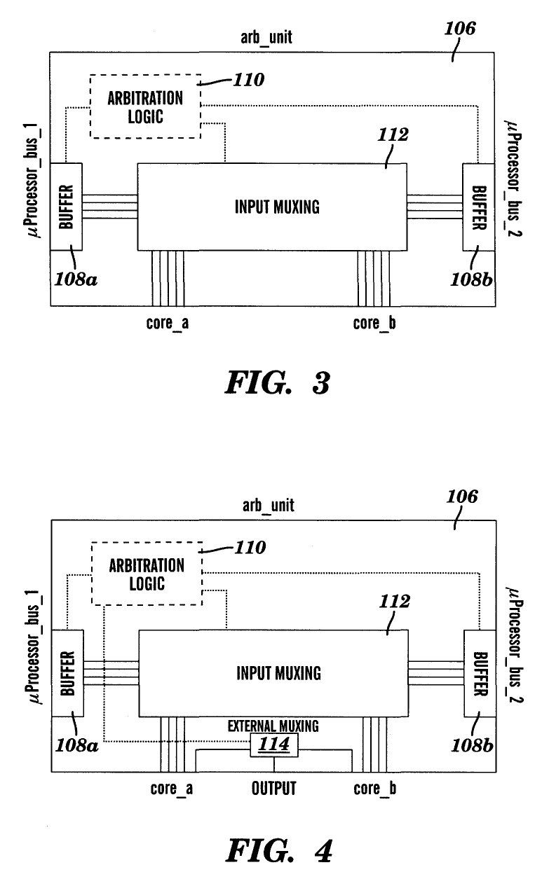

Referring now to FIG. 3, there is shown a schematic diagram of an individual arbitration unit 106, wherein the peripheral cores (core_a, core_b) associated therewith specifically service the processor internally with respect to the chip. One example of such a core is a compression core, which does not utilize any external I/O's. As such, the arbitration unit 106 will simply detect a request from one of the processor busses (104a, 104b of FIG. 2) through an associated internal buffer device 108a, 108b. Arbitration logic 110 within the arbitration unit 106 is used to assign a peripheral (core_a or core_b) to the requesting processor, and the assigned peripheral then completes the request and returns the requested data to the arbitration unit 106, which in turn routes the data on to the requesting processor through input muxing circuitry 112. At this point, the peripheral's immediate task is considered complete and is thus ready for a new request from either processor.

### Embodiment 2

### External Output Only

FIG. 4 is a schematic diagram of another individual arbitration unit 106, wherein the peripheral cores (core_a, core_b) associated therewith only pass data outward from the chip. An example of such a core type would be a control signal, or possibly a unidirectional parallel port. In this implementation of the arbitration unit 106, the state of the peripheral need only be kept during an actual transfer of data. Once the data has passed out from the peripheral core, the core is free to accept another transfer request from either processor. Thus, in addition to the elements of the arbitration unit 106 shown in FIG. 3, external muxing circuitry 114 is included in the configuration of FIG. 4 for handling the data passed from the cores to the external output path off chip.

### Embodiment 3

### External Input and Output, Response Based

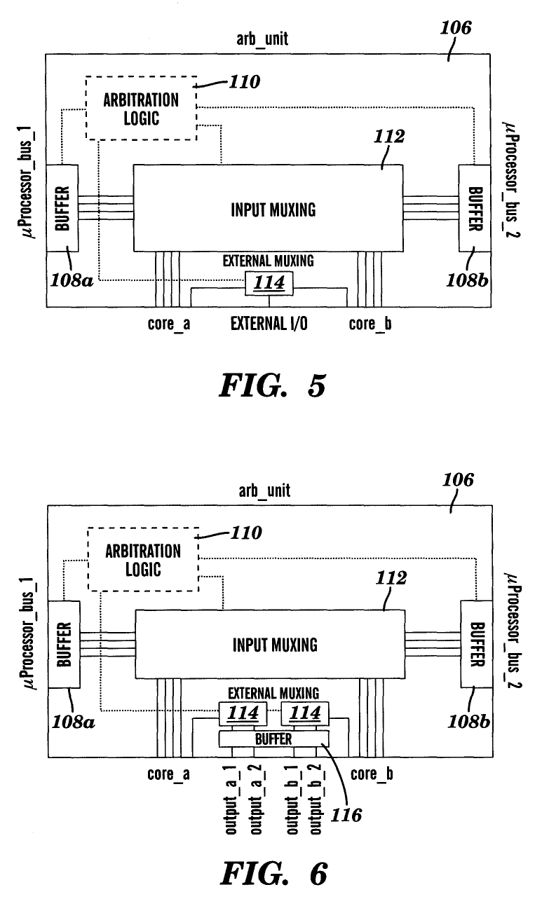

Referring now to FIG. 5, there is shown a schematic diagram of another individual arbitration unit 106, wherein the peripheral cores (core_a, core_b) associated therewith are configured to accept data for external transfer out, to further wait for a reply from the external device, and then to transfer that reply back to the requesting processor. One example of such a peripheral device would be a storage controller or memory device. The internal configuration of the arbitration unit 106 associated with this type of peripheral core is similar to the embodiment of FIG. 4, since the incoming data's expected destination may be easily determined by the arbitration unit logic 110. In particular, the arbitration unit 106 detects an outgoing signal on an external bus (external I/O), and then assigns a processor to the originating peripheral. This assignment would remain active until the arbitration unit detects a response coming back from the peripheral. After transferring that data back to the assigned processor, the peripheral becomes available for another assigned task.

### Embodiment 4

### External Input and Output, Arbitrary

Finally, FIG. 6 is a schematic diagram of still another individual arbitration unit 106, wherein the peripheral cores (core_a, core_b) associated therewith are able to receive incoming external data at any time. An example of such a peripheral core would be a USB or serial port. This type of arbitration unit may be configured by creating an external connection for each possible combination of processor and peripheral core. In the example illustrated, given a pair of processors and a pair of peripheral cores, there are four external connections provided with the arbitration unit (output_a_{—}1, output_a_{—}2, output_b_{—}1, and output_b_{—}2), as well as an external buffer device 116.

Thus configured, the arbitration unit 106 is able to identify the target destination by simply looking at the bus that the data arrived on. The appropriate processor would then look for a free peripheral and stream the incoming data to the free peripheral. This also establishes a peripheral/processor association such the arbitration unit would know where to send the data to once it flows through the peripheral. After each transfer in either direction, the arbitration unit then closes the association and considers the peripheral free again. The arbitration takes place at the digital level of the bus; i.e., there would be a physical layer for each external output, and the muxing would be carried out above the physical layer.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for implementing arbitration between one or more shared peripheral core devices in a system on chip (SOC) integrated circuit architecture, comprising:
a first microprocessor in communication with a first system bus;
a second microprocessor in communication with a second system bus;
at least one peripheral core device accessible by both said first microprocessor and said second microprocessor; and
an arbitration unit in communication with said first system bus and said second system bus;
wherein said arbitration unit is configured to control communication between said at least one peripheral core device and said first and second microprocessors.

2. The system of claim 1, further comprising a plurality of arbitration units, wherein each of said plurality of arbitration units is configured to control communication between said first system bus and said second system bus, and a group of peripheral core devices associated therewith.

3. The system of claim 1, wherein said arbitration unit further comprises:
a first buffer device coupled to said first system bus;
a second buffer device coupled to said second system bus;
input multiplexing circuitry in communication with said first buffer device, said second buffer device and said at least one peripheral core device; and
arbitration logic in communication with said first buffer device, said second buffer device and said input multiplexing circuitry.

4. The system of claim 3, wherein:
said arbitration logic is configured to detect a request for access to said at least one peripheral core device by a requesting one of said first and second microprocessors;
said arbitration logic is further configured to determine the existence of a free peripheral from said at least one peripheral core device; and
said arbitration logic is further configured to implement communication between a determined free peripheral and said requesting one of said first and second microprocessors;
wherein said arbitration logic is further configured to inform said requesting one of said first and second microprocessors whenever no free peripheral is presently available.

5. The system of claim 4, wherein said arbitration unit is configured to internally note an assignment between a free peripheral and a requesting one of said first and second microprocessors.

6. The system of claim 4, wherein:
said at least one peripheral core device is configured to communicate data externally from the (SOC) integrated circuit architecture through an external output path; and
said arbitration unit further comprising external multiplexing circuitry in communication with said at least one peripheral core device and said external output path.

7. The system of claim 4, wherein:
said at least one peripheral core device is configured to communicate data to and from the (SOC) integrated circuit architecture through an external bus; and
said arbitration unit further comprising external multiplexing circuitry in communication with said at least one peripheral core device and said external output path.

8. The system of claim 7, wherein:
said arbitration unit is configured to internally note an assignment between a free peripheral and a requesting one of said first and second microprocessors; and
said arbitration unit is configured to maintain said assignment until a response is received from said free peripheral indicating a completed data transfer.

9. The system of claim 4, wherein:
said at least one peripheral core device is configured to communicate data to and from the (SOC) integrated circuit architecture through an associated external connection for each of said first and second microprocessors; and
said arbitration unit further comprising external multiplexing circuitry in communication with said at least one peripheral core device and said external connections; and
said arbitration unit further comprising an external buffer device coupled between said external multiplexing circuitry and said external connections.

10. The system of claim 9, wherein:
said arbitration unit is configured to receive incoming data from one of said external connections and identify a target destination for said incoming data;
said arbitration unit is configured to internally note an assignment between a free peripheral and said target destination; and
said arbitration unit is configured to maintain said assignment until the completion of a completed data transfer between said one of said external connections and said target destination, through said free peripheral.

11. A method for implementing arbitration between one or more shared peripheral core devices in a system on chip (SOC) integrated circuit architecture, the method comprising:
configuring a first microprocessor in communication with a first system bus;
configuring a second microprocessor in communication with a second system bus;
configuring at least one peripheral core device to be accessible by both said first microprocessor and said second microprocessor; and
configuring an arbitration unit in communication with said first system bus and said second system bus, wherein said arbitration unit controls communication between said at least one peripheral core device and said first and second microprocessors.

12. The method of claim 11, further comprising a configuring plurality of arbitration units to control communication between said first system bus and said second system bus, and a group of peripheral core devices associated therewith.

13. The method of claim 11, wherein said arbitration unit further comprises:
a first buffer device coupled to said first system bus;
a second buffer device coupled to said second system bus;
input multiplexing circuitry in communication with said first buffer device, said second buffer device and said at least one peripheral core device; and
arbitration logic in communication with said first buffer device, said second buffer device and said input multiplexing circuitry.

14. The method of claim 13, wherein:
said arbitration logic detects a request for access to said at least one peripheral core device by a requesting one of said first and second microprocessors;
said arbitration logic determines the existence of a free peripheral from said at least one peripheral core device; and
said arbitration logic implements communication between a determined free peripheral and said requesting one of said first and second microprocessors, and informs said requesting one of said first and second microprocessors whenever no free peripheral is presently available.

15. The method of claim 14, wherein said arbitration unit internally notes an assignment between a free peripheral and a requesting one of said first and second microprocessors.

16. The method of claim 14, wherein:
said at least one peripheral core device communicates data externally from the (SOC) integrated circuit architecture through an external output path; and
said arbitration unit further includes external multiplexing circuitry in communication with said at least one peripheral core device and said external output path.

17. The method of claim 14, wherein:
said at least one peripheral core device communicates data to and from the (SOC) integrated circuit architecture through an external bus; and
said arbitration unit further includes external multiplexing circuitry in communication with said at least one peripheral core device and said external output path.

18. The method of claim 17, wherein:
said arbitration unit internally notes an assignment between a free peripheral and a requesting one of said first and second microprocessors; and
said arbitration unit maintains said assignment until a response is received from said free peripheral indicating a completed data transfer.

19. The method of claim 14, wherein:
said at least one peripheral core device communicates data to and from the (SOC) integrated circuit architecture through an associated external connection for each of said first and second microprocessors; and
said arbitration unit further includes external multiplexing circuitry in communication with said at least one peripheral core device and said external connections; and
said arbitration unit further includes an external buffer device coupled between said external multiplexing circuitry and said external connections.

20. The method of claim 19, wherein:
said arbitration unit receives incoming data from one of said external connections and identifies a target destination for said incoming data;
said arbitration unit internally notes an assignment between a free peripheral and said target destination; and
said arbitration unit maintains said assignment until the completion of a completed data transfer between said one of said external connections and said target destination, through said free peripheral.
